(19) United States
(12) Patent Application Publication
(10) Pub. No.: US 2002/0080288 A1
(43) Pub. Date: Jun. 27, 2002

(54) Reproduction device and method

(75) Inventor: Robert J. Davies, Horley (GB)

Correspondence Address: Corporate Patent Counsel, U.S. Philips Corportion, 580 White Plains Road, Tarrytown, NY, 10591, US

(73) Assignee: KONINKLIJKE PHILIPS ELECTRONICS N.V.

(21) Appl. No.: 10/015,850

(22) Filed: Dec. 10, 2001

(30) Foreign Application Priority Data
Dec. 27, 2000 (GB) 0031608.3

(51) Int. Cl. H04N 5/64

(52) U.S. Cl. 348/838

(57) ABSTRACT

The invention relates to mobile devices (1) able to receive and reproduce information, for example as sound. The invention is particularly applicable to small mobile devices with no or inconvenient user interfaces. In order to update filter blocks to select message streams, filter blocks are transmitted from a separate transmitter, and recorded in memory (11). The filter blocks then control a filter (9) to replay messages from selected message streams on the output device or devices (19,21) of the mobile device (1).

The invention relates to a reproduction device, and in particular to a portable reproduction device for playing broadcast messages, and to a corresponding method.

Recent years have seen a great increase in subscribers world-wide to mobile telephone networks and, through advances in technology and the addition of functionalities, cellular telephones have become widespread. A result of this is that a mobile information society is developing, with personalised and localised services becoming increasingly more important. Such “Context-Aware” (CA) mobile telephones are used with low power, short range base stations in places like shopping malls to provide location-specific information. This information might include local maps, information on nearby shops and restaurants and so on. The user's CA terminal may be equipped to filter the information received according to pre-stored user preferences and the user is only alerted if an item of data of particular interest has been received.

An example of a CA terminal is given in U.S. Pat. No. 5,835,861 which discloses the use of wireless telephones within the context of advertisement billboards. The user of a wireless telephone obtains the telephone number of a vendor by activating his/her wireless telephone to transmit a prompt signal to an active advertisement source and to receive from the advertisement source a response signal containing the telephone number of the advertising vendor. The telephone number can then be used to automatically place a call to that vendor via the public switched telephone network. Alternatively, the telephone number can be stored for use later on. This arrangement can be used to place a call to a vendor without having to either memorise the telephone number or to write it down. The signals between the billboard and the caller can be transmitted as modulated infrared (IR) signals.

CA content may be provided using the techniques described in two commonly-assigned copending patent applications, “Data Delivery Through Beacons” (filed as GB002099.8 filed on Aug. 15, 2000) and “Localised Audio Data Delivery” (filed as GB0015453.4 on Jun. 26, 2000), the contents of which are incorporated herein by reference.

A summary of the techniques described in these copending applications for including audio signals in radio beacon signals follows. “Data Delivery through Beacons” describes techniques for allowing a terminal to receive broadcast messages without setting up a two-way communications link with a Bluetooth (or similar) beacon in spite of the fact that the Bluetooth protocol does not foresee such links. The application describes appending an extra data field to the inquiry messages output by Bluetooth beacons, capable of carrying a user-defined payload. The field, being at the end of the inquiry messages, can be safely ignored by conventional Bluetooth receivers. The extra data field is output in the guard space provided at the end of a conventional Bluetooth inquiry packet; although the guard space is reduced, apparatus for carrying out the frequency shift intended to occur in the guard space is available that can still shift frequency fast enough in the reduced guard space proposed.

“Localised Audio Data Delivery” describes the inclusion of audio data messages in signals broadcast by a beacon. The messages add data fields including the audio data; the data fields may include such data as the codec type, language, type of audio data, and of course the main body of audio data.

It would be beneficial for context aware functionality to be provided in small and lightweight equipment. However, it is not generally desirable that all messages reaching the equipment are reported to the user, since some or indeed most messages will be relevant to only some users. This is particularly important in data rich environments. In order that the user can be provided with relevant information some measure of flexibility in the filtering should be included. There is thus a need to provide filter flexibility in small lightweight equipment that may lack display screens, keypads and other conventional means of displaying and updating filter information.

Even on lightweight equipment that does possess input and display devices, it may be very inconvenient and require patience and dexterity to manipulate the input devices to correctly select and update filter coefficients. It would thus be desirable to minimise the need for such manipulations.

According to the invention there is provided a portable reproduction device for playing selected messages from a plurality of broadcast signal message streams, the portable reproduction device comprising a receiver for receiving broadcast messages; a filter for filtering the received messages and selecting messages from one or more selected message streams, the filter connected to a memory for storing a filter block identifying the selected message streams; and an output device for outputting the filtered messages, wherein the portable reproduction device is arranged to receive filter blocks transmitted to the portable reproduction device and to store them in the filter memory to update the filter and hence update the selection of message streams for output.

In this way, the absence of input-output devices or the difficulty of using small input output devices on the portable device need not cause a problem.

The portable reproduction device may include code for causing the device to receive the filter blocks and to store them in the memory. The code may likewise be stored in the memory, or additional memory in a known way.

The messages for reproduction may be delivered through any of a number of systems, normally radio systems, but not excluding other local broadcasting systems such as infra red systems. It is envisaged that the Bluetooth communications protocol will be very suitable for transmitting messages and widely adopted. Thus, the receiver may be a Bluetooth transceiver.

The filter blocks may be received on the same receiver used for receiving broadcast messages. The skilled person will readily envisage alternative techniques for transmitting and receiving the filter blocks. For example, the filter blocks may be supplied using an infra-red data connection, an electrical cable, or through a cellular link.

The filter blocks may be transmitted as messages in the same way as the broadcast messages for output. Accordingly, the portable reproduction device may include code for extracting filter blocks from received broadcast messages and for storing them in the filter memory.

The messages for output may in particular be messages making up an audio message stream. The output device may accordingly include a sound transducer for playing sound messages selected by the filter, together with a data buffer, audio codec and digital-to-analogue converter. A headphone configuration is a particularly convenient portable configuration for replaying audio, so the portable reproduction device may be in the form of a headphone having two diaphragms as output devices spaced apart by a headband. Another alternative is to use earphones connected to a small receiver.

It is desirable to provide some form of control so that only filter blocks desired by the user are stored, and unwanted intervention from third parties prevented. One way of addressing this issue is to provide a user control for accepting or rejecting filter blocks received at the portable user device. The control may be in the form of a switch with two positions, one for accepting filter blocks and one for rejecting filter blocks. The skilled person will readily conceive of other suitable user controls which will depend on the form and application of the portable reproduction device.

Another way of increasing security is for the portable reproduction device only to accept update filter blocks from preselected transmitters. Accordingly, the portable reproduction device may comprise code to check the origin of received filter blocks and to update the filter block in the filter memory only if the origin is on a list of acceptable transmitters.

In another aspect, the invention relates to a system for receiving broadcast messages including a portable reproduction device as described above and an update control device having an input for inputting information regarding the blocks to be filtered, a transmitter for transmitting messages to the portable device and code for accepting input information regarding the blocks to be filtered, preparing update filter blocks from the information and for transmitting the update filter blocks to the portable device using the transmitter.

In a yet further aspect, the invention relates to a method of processing broadcast messages, including the steps of transmitting an update filter block from an update control device to a portable reproduction device; storing the update filter block in memory in the portable reproduction device; receiving incoming broadcast messages on a receiver in the portable reproduction device; filtering incoming messages received in the portable reproduction device using a filter under control of the filter block, and playing messages selected by the filter block.

The method may further include the step of verifying update filter blocks received by the portable reproduction device to check whether to store the update filter blocks in memory.

A useful application of the invention is to provide a method of broadcasting information to waiting individuals, the method including programming a portable reproduction device with a filter block selecting predetermined message streams; providing at least one waiting individual with the portable reproduction device; broadcasting message streams; receiving incoming broadcast messages on the portable reproduction device; filtering incoming messages received in the portable reproduction device using a filter under control of the filter block; and playing the predetermined messages selected by the filter block.

One of the predetermined message streams may be an announcement message stream for transmitting announcements to the waiting individuals. In this way the waiting individuals may listen to one message stream, for example a music channel, and be advised of any announcements. This system may be of particular use in airport departure lounges or executive lounges, but is of much wider application; it might be useful in railway waiting areas, medical facilities, or indeed any situation in which individuals are waiting but also need to receive announcements.

A list of available filters may be broadcast, for example by the same transmitter that transmits the information. The user may then select a filter from the list for download. In an embodiment, a user, having checked in for a flight, may request a list of available filters corresponding to flights for which information is available and select the appropriate filter. Then, the user may select that filter for download.

By programming the portable reproduction device to only output messages relevant to the individual concerned, the individual is not disturbed by irrelevant announcements.

Specific embodiments of the invention will now be described, purely by way of example, with reference to the accompanying drawings, in which;

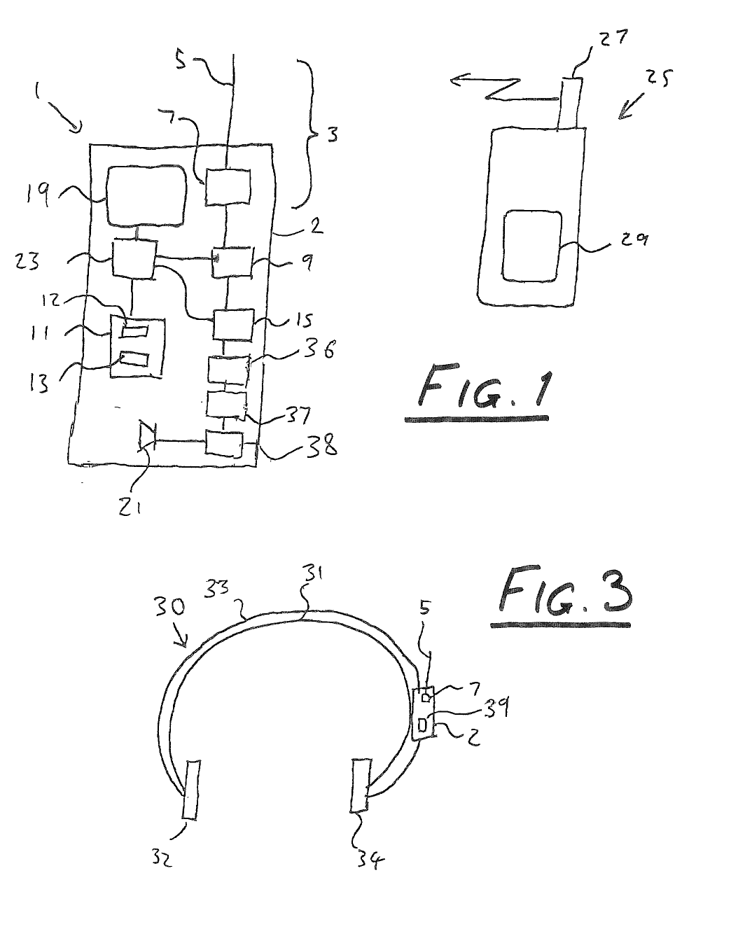

FIG. 1 shows a first embodiment of a system according to the invention;

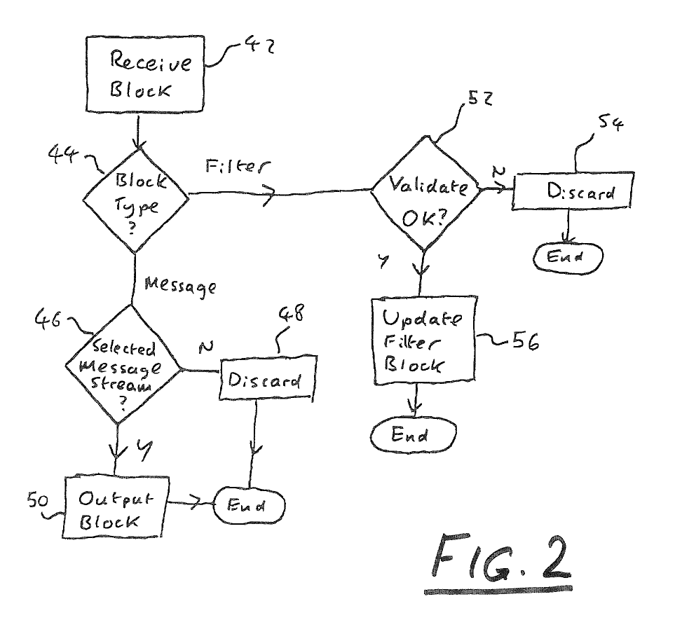

FIG. 2 is an illustrated flow diagram of processing of the first embodiment; and

FIG. 3 shows a second embodiment of a system according to the invention.

Referring initially to FIG. 1, a portable reproduction apparatus 1 embodying the invention comprises a body 2 having a receiver 3 for picking up broadcast messages. By way of example, the receiver may include an aerial 5 and a radio receiver 7, for example a Bluetooth transceiver, a cellphone transceiver, or other suitable transceiver for receiving broadcast radio messages. Other possibilities are also envisaged, such as a photo-sensitive device or intra-red transducer for receiving optical messages.

The received messages are passed through a filter unit 9 that acts in cooperation with a filter block 13 stored in memory 11 to filter the incoming messages based on information stored in the filter block. The filter unit may be implemented in hardware or alternatively software. Messages that are filtered out may be discarded and the remaining messages passed on.

A message processing block 15 is provided that can prepare the messages for output on one or more output devices. For example, the output devices can include a screen 19 and/or an output loudspeaker 21. As will be appreciated, the processing required will depend on the format of the messages and of the output device; text messages may be displayed on the screen whereas incoming messages that contain audio information can be processed by a data buffer 36, an audio codec 37 and a digital-to analogue converter 38 to produce an audio signal for feeding to the loudspeaker 21. Again, the output processing block can be carried out in software or hardware or a combination of the two.

The apparatus may include a processor 23 for running software to display a message, to control the flow of messages or any other tasks that may be required. Code 12 for the software is stored in the memory 11.

The reproduction apparatus 1 is intended for use with an update control apparatus 25 having a transmitter 27 for transmitting messages to the receiver 3 and an input device 29 for inputting information used to select the filter bank. The update control apparatus may be a mobile telephone or PDA, for example owned by the user of the portable apparatus. For some applications, a central control apparatus may be provided, for example at an aircraft check-in desk for updating the reproduction apparatus to receive appropriate flight information.

The code 12 causes the mobile device to carry out the processing illustrated schematically in FIG. 2.

When a block is received (step 42) the next step is to determine the block type (step 44). If, as usual, the block is a message block the reproduction apparatus tests (step 46) to determine if the message block corresponds to a selected message stream. If not, the block is discarded (step 48), otherwise the block is output (step 50).

If the block is determined to be a filter block, the block is validated (step 52). If the filter block fails the validation, it is discarded (step 54). Otherwise, the existing filter block is replaced (step 56).

Referring back to FIG. 1, in use, the update control apparatus 25 prepares a filter block and sends it as a message to the reproduction apparatus 1. This message, rather than being output, is instead directed by the message processing block 15 to be stored in the memory 11 as a new filter block 13, possibly after some processing to ensure that it is in a suitable format. Subsequent messages received are processed by the filter 9 using the new filter block 13.

It will be appreciated that the new filter block 13 should not normally block out messages containing further new filter blocks since that would then mean that new filter blocks could not be sent as messages. Nevertheless, such blocking may in some circumstances be desired.

Other means of changing or inputting the filter block may be provided, possibly by resetting the reproduction apparatus 1.

In the example, the reproduction apparatus 1 does not include an input keypad for inputting data. However, the absence of such a keypad is not critical and the invention may be useful in situations where it is simply inconvenient or not desired to use an input keypad or the like to input filter information.

The invention has particular application to reproduction of received audio message streams. Although loudspeaker reproduction of the audio received is possible, it is assumed that, for the majority of applications, headphones or earphones will be used as the audio data presentation means to avoid disturbing other people nearby.

Referring to FIG. 3, headphones 30 comprise left and right acoustic earpieces 32,34 spaced apart on a headband 31. The earpieces are transducers 32,34 electrically connected by wires 33 to an input/output apparatus body 2. The input/output apparatus body 2 contains the same components as described above with reference to FIG. 1 except that in this embodiment there is no screen 19 and the loudspeaker 21 is replaced by the headphones 32,34 away from the body. The receiver 7 is a Bluetooth transceiver capable of receiving Bluetooth messages and also capable of transmitting sufficient information to make a Bluetooth connection.

The headphones are intended to receive audio messages as will be explained in more detail below. The received audio messages are replayed in a way well known to those skilled in the art.

In the example, a switch 39 is provided on the reproduction apparatus to accept or reject replacement filter blocks. The switch may be a physical switch, but may alternatively be a software switch, accessed, for example, through a menu option on a mobile telephone or other device. The skilled person will realise that there are many other ways for implementing on/off switch functionality in a mobile device. Where the switch is provided, the validation step 52 (FIG. 2) may check that the switch is set to accept filter blocks as part of the validation procedure.

The filter block loaded into the memory 11 will vary depending on the audio required to be passed on. For example, the filter block may select a single audio stream for output.

Alternatively, the filter block may be set to normally output only a single stream but to interrupt this stream for any messages on an alternate message stream, which may, for example, be used for important announcements, sports scores, breaking news or other desired content.

The reproduction device may be used in a number of different applications, some of which will now be presented by way of example only. Many more will be apparent to persons skilled in the art.

For example, the headphones might be provided to individuals in airports, to allow them to listen to a selected audio stream whilst waiting for a flight. However, the selected audio stream may be interrupted to output messages relating to the flight that the wearer intends to catch. In this application, it will be appreciated that the filter block needs to include enough information to identify the user's flight details as well as the chosen audio stream. The headphones could for example be provided at an airport check in and programmed there with the necessary information. The user then can listen to a chosen audio stream, for example a music channel, and be kept abreast of any flight information relating to his flight without having to listen to much irrelevant flight information that would prevent the user from relaxing and listening to music.

It will be appreciated that the invention may also be useful in other waiting environments, not just airports.

Large public establishments like airports or railway stations use public address systems to keep customers up-to-date on information such as arrival and departure times. Sound bites can be used here, too. By updating the filter coefficients to select a particular flight or train of interest, a user can listen to music on headphones or wander into a quiet zone (such as an airline courtesy lounge or restaurant) without missing out on departure or arrival announcements. Supplementary information may be provided in the form of local directions to a terminal or platform, or announcement information in different languages.

It is not uncommon for a museum to accompany exhibits with a sound commentary. The cellular nature of Bluetooth allows exhibits to be appended with a specific commentary broadcast in a number of different languages, or in a single language time-staggered fashion so that the user does not have to wait too long for the start of the commentary. In a theatre (or, conceivably, in a cinema) supplementary audio channels might provide information for novice or blind audience members. Given the lengthy system delay, the commentary will be sent several tens of seconds ahead of the action it relates to, so this service is best suited to predictable (i.e. scripted) events.

Guide services are also possible, with audio guides on tour buses being an example. Whilst there are dedicated tourist buses in many cities, the invention provides a means whereby a multilingual tourist commentary may be provided on standard buses or trams that follow routes passing places of interest. A more mundane feature, but one that could be added to the previous or provided in its own right, is the delivery of station or stop announcements.

A city guide could make use of the beacon system to provide multilingual information and navigation aids. Road beacons may provide static or dynamic traffic information (“No left turn” or “Traffic Jam ahead”). The beacons could also support personal navigation, with a user registering a request for directions to a particular location, and these directions (“turn left at the end of the street”) being delivered on what is effectively a users personal audio channel. In addition, sites of interest (parks, gardens, historic buildings and so on) can use audio beacons with a “push” channel for tourist information as a means to attract further visitors.

Whilst the above-mentioned services may utilise high quality audio coding, some services will require it. Advertisers will want to be able to play musical jingles associated with them and their products, whilst shopping malls may use the system to provide optional background music. Purveyors of music or videos could use the system to broadcast the latest music or soundtracks to draw the crowds, perhaps to an MP3 downloading station. Audio quality from mono a.m. radio quality (16 kbit/s) upwards would be required to allow these features, with a trade-off as expected between the quality and the number of channels.

The invention is suitable for use with many different kinds of messages. A particular application is for audio data streams incorporated in Bluetooth inquiry sequences as explained in the copending commonly assigned patent applications referred to above.

From reading the present disclosure, other modifications will be apparent to persons skilled in the art. Such modifications may involve other features which are already known in the design, manufacture and use of fixed and portable communications systems, and systems and components for incorporation therein and which may be used instead of or in addition to features already described herein.

In particular, the skilled person will realise that the present invention does not require the use of the techniques described in the copending patent applications mentioned above and that the present invention may be used in combination with any suitable broadcast technique.

1. A portable reproduction device for playing selected messages from a plurality of broadcast signal message streams, the portable reproduction device comprising:
a receiver for receiving broadcast messages;
a filter for filtering the received messages and selecting messages from one or more selected message streams, the filter connected to a memory for storing a filter block identifying the selected message streams; and
an output device for outputting the filtered messages;
wherein the portable reproduction device is arranged to receive filter blocks transmitted to the portable reproduction device and to store them in the filter memory to update the filter and hence update the selection of message streams for output.

2. A portable reproduction device according to claim 1, wherein the filter blocks are received on the receiver for receiving broadcast messages.

3. A portable reproduction device according to claim 2, arranged to extract filter blocks from received broadcast messages and to store them in the filter memory.

4. A portable reproduction device according to claim 1, wherein the receiver is a Bluetooth transceiver.

5. A portable reproduction device according to claim 1, further comprising a sound transducer for playing audio messages selected by the filter.

6. A portable reproduction device according to claim 5, in the form of a headphone having two diaphragms spaced apart by a headband.

7. A portable reproduction device according to claim 1, further comprising a user control for accepting or rejecting filter blocks received at the portable user device.

8. A portable reproduction device according to claim 1, arranged to check the origin of received filter blocks and to update the filter block in the filter memory only if the origin is on a list of acceptable transmitters.

9. A system for receiving broadcast messages comprising:
a portable reproduction device according to claim 1; and
an update control device having an input for inputting information regarding the blocks to be filtered, a transmitter for transmitting messages to the portable reproduction device, wherein the update control device is arranged to accept input information regarding the blocks to be filtered, to prepare update filter blocks from the information and to transmit the update filter blocks to the portable device using the transmitter.

10. A system according to claim 9, wherein update filter blocks are transmitted using a secure protocol.

11. A method of processing broadcast messages, including the steps of:
transmitting an update filter block from an update control device to a portable reproduction device;
storing the update filter block in memory in the portable reproduction device;
receiving incoming broadcast messages on a receiver in the portable reproduction device;
filtering incoming messages received in the portable reproduction device under control of the filter block, and
playing messages selected by the filter block.

12. A method according to claim 11, further comprising the step of verifying update filter blocks received by the portable reproduction device to check whether to store the update filter blocks in memory.

13. A method according to claim 11, including transmitting the update filter block to the portable reproduction device so that it is received on the receiver for receiving broadcast messages.

14. A method according to claim 11, wherein the incoming broadcast messages are Bluetooth messages.

15. A method according to claim 11, wherein the incoming broadcast messages are replayed as sound.

16. A method of broadcasting audio information to waiting individuals provided with a portable reproduction device, comprising:
programming the portable reproduction device with a filter block selecting predetermined message streams;
broadcasting audio message streams;
receiving the broadcast messages on the portable reproduction device;
filtering incoming messages received in the portable reproduction device using a filter under control of the filter block to select only predetermined message streams; and
playing the selected incoming messages selected by the filter block.

17. A method according to claim 16, wherein one of the predetermined message streams is an announcement message stream for transmitting announcements to the waiting individuals.
